(19) United States
(12) Patent Application Publication
(10) Pub. No.: US 2018/0260096 A1
(43) Pub. Date: Sep. 13, 2018

(54) OPERATION SYSTEM, OPERATION METHOD, AND OPERATION PROGRAM

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Kazuhiro KAMIYA, Okazaki (JP); Yoshito MOMIYAMA, Chita (JP); Kazuyuki UEDA, Okazaki (JP); Seiichi TANAKA, Toyota (JP); Kensuke HANAOKA, Toyota (JP); Yusuke TAKEUCHI, Miyoshi (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 15/753,062

(22) PCT Filed: Jun. 2, 2016
(86) PCT No.: PCT/JP2016/066435

§ 371 Date: Feb. 15, 2018

(30) Foreign Application Priority Data
Sep. 24, 2015 (JP) 2015-187099

(51) Int. Cl. G06F 3/0481; G06F 3/0354

(52) U.S. Cl. CPC G06F 3/04812; G06F 3/03547

(57) ABSTRACT

Operation systems, methods, and programs display a first display screen and a second display screen. Each of the first display screen and the second display screen include a plurality of control images to be selected to control an object. The systems, methods, and programs receive a signal to move a moving point in the display area. Based on the received signal, the systems, methods, and programs determine an amount of movement of the moving point in the display area with respect to an amount of operation in the operation area, and change the amount of movement with respect to the amount of operation when a distance between the plurality of control images on the first display screen is different from a distance between the plurality of control images on the second display screen due to switching from the first display screen to the second display screen.

### TECHNICAL FIELD

Related technical fields include operation systems, methods, and programs.

### BACKGROUND

Conventionally, as a technique for controlling a to-be-controlled object, there is known a display system including a display on which images of a plurality of control items and a pointer are displayed; and a touchpad to be operated to select a control item on the display with the pointer (see, for example, JP 2015-75946 A). In the display system, a user's operation on the touchpad is detected and the pointer on the display is moved based on a result of the detection.

### SUMMARY

However, in the technique described in, since the pointer on the display is only moved simply by a distance corresponding to the detected amount of user's operation, it may be difficult to select a desired image. For example, when a plurality of images on the display are crowded together, the distances between the plurality of images become narrow. Thus, selection of a desired image requires a detailed operation on the touchpad, and accordingly, it takes time and effort to perform an operation on the touchpad to select the desired image. In addition, for example, when a plurality of images on the display are apart from each other, the distances between the plurality of images become large. Thus, selection of a desired image requires a large operation on the touchpad, and accordingly, it takes time and effort to perform an operation on the touchpad to select the desired image.

Exemplary embodiments of the broad inventive principles described herein provide an operation system, an operation method, and an operation program that are capable of improving the ease of operation for an operation to select a control image.

Exemplary embodiments provide operation systems, methods, and programs that display a first display screen and a second display screen. Each of the first display screen and the second display screen include a plurality of control images to be selected to control an object. The systems, methods, and programs receive a signal to move a moving point in the display area. Based on the received signal, the systems, methods, and programs determine an amount of movement of the moving point in the display area with respect to an amount of operation in the operation area, and change the amount of movement with respect to the amount of operation when a distance between the plurality of control images on the first display screen is different from a distance between the plurality of control images on the second display screen due to switching from the first display screen to the second display screen.

According to the operation system, operation method, and operation program, when a distance between a plurality of control images on a first display screen is different from a distance between the plurality of control images on a second display screen due to switching of the display screen of the display means from the first display screen to the second display screen, the amount of movement with respect to the amount of operation is changed. Thus, for example, when a distance between the plurality of control images has been changed, the amount of movement of the moving point in the display area with respect to the amount of operation in the operation area can be changed, enabling to improve the ease of operation for an operation to select the plurality of control images.

### BRIEF DESCRIPTION OF DRAWINGS

FIG. 1 is a block diagram illustrating an in-vehicle apparatus according to an embodiment.

FIG. 2 is a diagram illustrating a touchpad and a display.

FIG. 3 is a diagram illustrating the display on which switching images in an operable state and switching images in an inoperable state are displayed, and the touchpad.

FIG. 4 is a flowchart of an amount-of-movement adjustment process.

FIG. 5 is a flowchart of a movement process.

### DETAILED DESCRIPTION OF EXEMPLARY EMBODIMENTS

An embodiment of an operation system, an operation method, and an operation program will be described in detail below with reference to the drawings. Note, however, that the embodiment is not limiting.

An operation system is a system that determines the amount of movement of a moving point in a display area of display means with respect to the amount of operation in an operation area of operating means, based on distances between a plurality of control images to be selected to control a to-be-controlled object. In particular, the operation system is a system that changes the amount of movement with respect to the amount of operation when distances between the plurality of control images on a first display screen are different from distances between the plurality of control images on a second display screen due to the switching of a display screen of the display means from the first display screen to the second display screen. Apparatuses that function as the operation system include a device that is operated to control a to-be-controlled object and that is connected by wire or wireless to the to-be-controlled object, a device formed integrally with or separately from a to-be-controlled object, or one function of the devices, and specific examples include an in-vehicle apparatus and a terminal apparatus. The “in-vehicle apparatus” is an apparatus mounted on a vehicle, and is specifically a concept including a navigation apparatus for vehicle mounting, etc. In addition, the “terminal apparatus” is an apparatus having a predetermined computer mounted thereon, and is specifically a concept including a stationary computer apparatus, a smartphone, a portable navigation apparatus, etc.

In addition, the “to-be-controlled object” is an object to be controlled and is a device connected by wire or wireless to the operating means, a device formed integrally with or separately from the operating means, or one function of the devices, and is specifically a concept including an in-vehicle apparatus or various types of apparatuses other than an in-vehicle apparatus that are mounted on a vehicle having mounted thereon an in-vehicle apparatus (e.g., an air conditioner). In addition, the “control image” is an image to be selected to control the to-be-controlled object, and is specifically a concept including a switching image, an input image, etc. In addition, the “operating means” is means for operating a moving point and is specifically an apparatus for inputting information for an operation, and is a concept including, for example, a touchpad, a mouse, a trackball, and a joystick. In addition, the “amount of operation” is the amount of operation performed on the operating means and is a concept including, for example, the moving distance of a user's finger on a touchpad. In addition, the “display means” is means for displaying information and has a display screen to be displayed thereon, and is specifically a concept including a display, etc. Note that the “display screen” has an image to be displayed thereon, and specifically has at least a plurality of control images (i.e., at least a plurality of control images are included) to be displayed thereon, and is a concept including, for example, a menu screen including a plurality of (e.g., 8 to 10) switching images serving as control images, or a 50-sound input screen including a plurality of (e.g., 50) character input images (e.g., images for Japanese kana characters to be inputted to input Japanese 50 sounds) serving as control images. In addition, “due to the switching of a display screen of the display means from the first display screen to the second display screen” is a concept corresponding to a case in which the display screen of the display means is switched from the first display screen to the second display screen. The “first display screen” is a specific one display screen and the “second display screen” is a display screen to be switched after the first display screen. These “first display screen” and “second display screen” are any screen as long as the screens are sequentially displayed, and are a concept including, for example, display screens including control images of the same type with different display states, or display screens including control images of different types. The “display screens including control images of the same type with different display states” is a concept corresponding to, for example, screens including switching images with different display states on a menu screen (as an example, two menu screens including different switching images which are displayed toned down), or screens including character input images with different display states on a 50-sound input screen (as an example, two 50-sound input screens including different character input images which are displayed toned down). The “display screens including control images of different types” is a concept corresponding to different display screens such as a menu screen and a 50-sound input screen. In addition, the “moving point” is a point that moves on the display means and is specifically a reference point serving as a reference for selecting a control image, and is a concept including, for example, a pointer or a cursor displayed on the display or information about the display for selecting a control image (e.g., coordinate information on the display) which is not displayed on the display. In addition, the “amount of movement” is the amount of movement made by the moving point, and is specifically a concept including the moving distance of the pointer on the display, etc.

In the embodiment, description is made of a case in which the “operation system” is an “in-vehicle apparatus,” the “control images” are “switching images,” the “first display screen” and “second display screen” are “screens including switching images with different display states on a menu screen,” the “operating means” is a “touchpad,” the “moving point” is a “pointer,” the “amount of operation” is the “moving distance of a user's finger on the touchpad,” and the “amount of movement” is the “moving distance of the pointer on the display.”

(Embodiment)

An embodiment will be described. Note that in the following a vehicle having an in-vehicle apparatus mounted thereon (a vehicle on which a user that operates an in-vehicle apparatus rides) is described, referred to as “the vehicle.” In addition, “the vehicle” is a concept including, for example, a four-wheeled vehicle, a two-wheeled vehicle, and a bicycle. In the following, a case in which the vehicle is a four-wheeled vehicle will be described.

(Configuration)

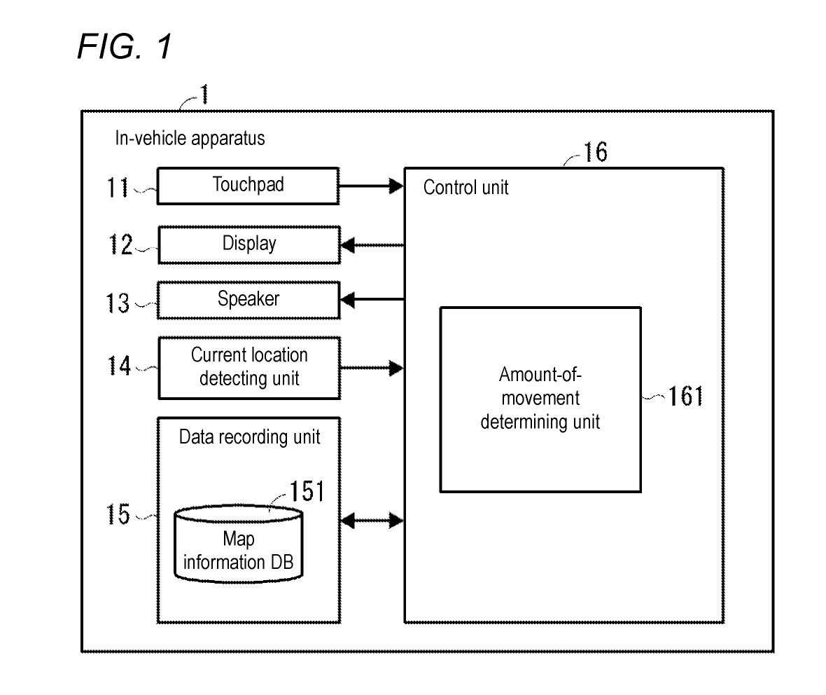

First, an in-vehicle apparatus 1 according to the present embodiment will be described. FIG. 1 is a block diagram illustrating an in-vehicle apparatus according to an embodiment. As shown in FIG. 1, the in-vehicle apparatus 1 schematically includes a touchpad 11, a display 12, a speaker 13, a current location detecting unit 14, a storage medium (e.g., data recording unit 15), and a control unit 16.

(Configuration—Touchpad)

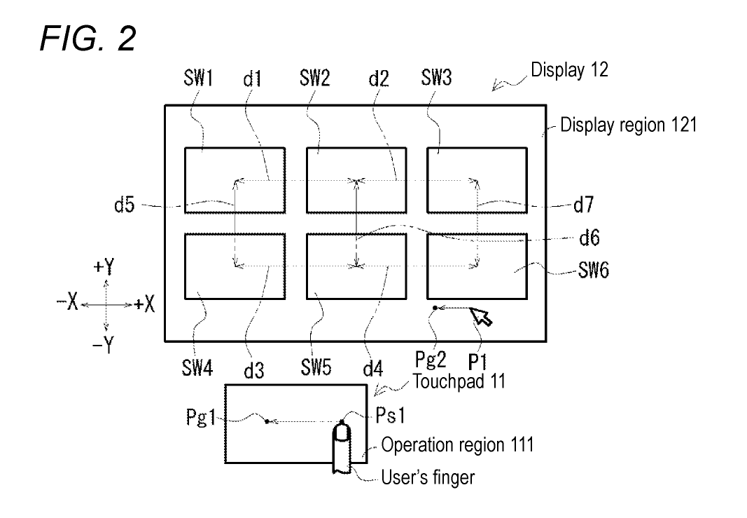

The touchpad 11 is operating means for accepting various types of operation inputs from a user by being pressed with a finger of the user, etc. A specific configuration of the touchpad 11 is any, but for example, a known touchpad including operation position detecting means of a resistive membrane type, an electrostatic capacitive type, etc., can be used. Here, for example, a region that is provided with the operation position detecting means of the touchpad 11 is described below, referred to as an operation area. FIG. 2 is a diagram illustrating the touchpad and the display. An operation area 111 of the touchpad 11 shown in this FIG. 2 is a region for performing operations and is specifically a region that is not laid over a display area 121 of the display 12 which will be described later.

(Configuration—Display)

Referring back to FIG. 1, the display 12 is display means for displaying various types of images. A specific configuration of the display 12 is any, but, for example, a flat panel display like a known liquid crystal display or organic EL display that has the display area 121 shown in FIG. 2 can be used. The display area 121 is a region for displaying various types of images and is specifically a region that is not laid over the operation area 111 of the touchpad 11. Note that a screen displayed in the display area 121 of this FIG. 2 corresponds to an example of a “first display screen.”

(Configuration—Speaker)

Referring back to FIG. 1, the speaker 13 is audio output means for outputting information by audio. A specific mode of audio outputted from the speaker 13 is any, and synthetic audio which is generated as necessary or pre-recorded audio can be outputted.

(Configuration—Current Location Detecting Unit)

The current location detecting unit 14 is current location detecting means for detecting a current location of the in-vehicle apparatus 1. The current location detecting unit 14 has a GPS or a geomagnetic sensor (none of which is shown), and detects the current location (coordinates), bearing, and the like, of the in-vehicle apparatus 1 by a known method.

(Configuration—Data Recording Unit)

The data recording unit 15 is recording means for recording programs and various types of data which are required for the operation of the in-vehicle apparatus 1. For example, the data recording unit 15 is formed using a hard disk (not shown) serving as an external recording apparatus. Note, however, that instead of a hard disk or together with a hard disk, any other storage medium including a magnetic storage medium like a magnetic disc or an optical storage medium like a DVD or a Blu-ray Disc can be used.

In addition, the data recording unit 15 includes a map information DB 151.

The map information DB 151 is map information storing means for storing map information. The “map information” as used herein is information for presenting a map to the user and is specifically information required to identify various types of locations including roads, intersections on the roads, structures on the roads, and facilities. For example, the map information is configured to include node data concerning each node set on a road (e.g., node IDs and coordinates), link data concerning each link set on a road (e.g., link IDs, link names, connected node IDs, road coordinates, road types (e.g., a minor street, a local road, a national primary road, and an expressway), road widths, and the number of lanes), planimetric feature data (e.g., signals, road signs, guardrails, and facilities), topographic data, etc. Such map information in the map information DB 151 is recorded by being inputted through a predetermined storage medium, or recorded by receiving information distributed from a map distribution center which is not shown.

(Configuration—Control Unit)

The control unit 16 is control means for controlling the in-vehicle apparatus 1. Specifically, the control unit 16 is a computer configured to include a CPU, various types of programs (including a basic control program such as an OS and application programs that run on the OS and implement specific functions) which are interpreted and executed on the CPU, and a storage medium such as an internal memory such as a RAM for storing the programs and various types of data. In particular, an operation program according to the embodiment substantially forms each unit of the control unit 16 by being installed on the in-vehicle apparatus 1 through an arbitrary storage medium or network. (As used herein, the term “storage medium” is not intended to encompass transitory signals.)

In addition, the control unit 16, in terms of function concept, includes an amount-of-movement determining unit 161.

The amount-of-movement determining unit 161 is amount-of-movement determining means for determining a moving distance (amount of movement) of a pointer P1 in the display area 121 of the display 12 with respect to a moving distance (amount of operation) of a user's finger in the operation area 111 of the touchpad 11, based on the distances between switching images SW1 to SW6 of FIG. 2. In particular, the amount-of-movement determining unit 161 is amount-of-movement determining means for changing the amount of movement with respect to the amount of operation when the distances between a plurality of switching images SW1 to SW6 on a first display screen (specifically, switching images SW1 to SW6 that are switched to an operable display state) are different from the distances between a plurality of switching images SW1 to SW6 on a second display screen (specifically, switching images SW1 to SW6 that are switched to an operable display state) due to the switching of a display screen of the display 12 from the first display screen to the second display screen. Here, the “switching images” SW1 to SW6 of FIG. 2 are control images to be selected to control a to-be-controlled object, and are specifically images to be selected by the pointer P1 to control the in-vehicle apparatus 1. Note that the expression “selected by the pointer P1” refers to the selection using the pointer P1. For a specific selection technique, any technique can be used, but here, the following description is made assuming, for example, that a selection is made by tapping (i.e., striking lightly) the operation area 111 of the touchpad 11 with a user's finger, with the pointer P1 placed over any of the switching images SW1 to SW6 to be selected. In addition, the display mode of the switching images SW1 to SW6 can be set arbitrarily, but here, the following description is made assuming, for example, that the display mode is set by the control unit 16 in a “display process” which will be described later. In addition, for a technique for determining, by the amount-of-movement determining unit 161, a moving distance of the pointer P1 (hereinafter, the moving distance of the pointer) in the display area 121 of the display 12 with respect to a moving distance of a user's finger in the operation area 111 of the touchpad 11 (hereinafter, the operation distance on the touchpad), any technique can be used, but here, the following description is made assuming, for example, that the moving distance of the pointer is determined using a “moving distance determination arithmetic expression” which will be described later.

The “moving distance determination arithmetic expression” is an arithmetic expression for determining a moving distance of the pointer with respect to an operation distance on the touchpad. For example, “Y=d×α×X (note that Y: the moving distance of the pointer, X: the operation distance on the touchpad, d: the distance between switching images on the display 12, and α: an adjustment coefficient (the value is a positive natural number or decimal))” can be used. Here, the adjustment coefficient “α” of the moving distance determination arithmetic expression can be arbitrarily set based on, for example, a predetermined experiment concerning user's ease of operation as long as the adjustment coefficient “α” is a positive natural number or decimal, but here, the following description is made assuming, for example, that the adjustment coefficient “c” is set to “0.5.” In addition, for “d,” for example, a value in units of centimeters is used, but the following description is made assuming that “d×α” is dimensionless so that “Y” and “X” have the same unit. The moving distance determination arithmetic expression is recorded in the memory of the control unit 16, and is read and used when a “movement process” which will be described later is performed, or is updated in an “amount-of-movement adjustment process” which will be described later. Note that a process to be performed by each unit of the control unit 16 will be described later.

(Processes)

Next, a display process, an amount-of-movement adjustment process, and a movement process which are performed by the in-vehicle apparatus 1 thus configured will be described. For the display process among the processes, a known process can be used, and thus, only a summary thereof is described. For the amount-of-movement adjustment process and the movement process, details will be described.

(Processes—Display Process)

First, the display process will be described. The “display process” is a process for displaying images. Specifically, the “display process” is a process of displaying switching images SW1 to SW6 in the display area 121 of FIG. 2, and is a process of, for example, displaying or hiding the images or changing the display mode. The timing at which the display process is performed is any timing, but assuming, for example, that when the power to the in-vehicle apparatus 1 is turned on, the display process starts and is repeatedly performed, description is made from when the process has started.

When the display process starts, the control unit 16 of FIG. 1 determines whether the vehicle is stopped or traveling. Specifically, a result of detection by a predetermined rotation detection sensor that detects the rotation of tires of the vehicle is obtained, and the determination is made based on the obtained result of detection.

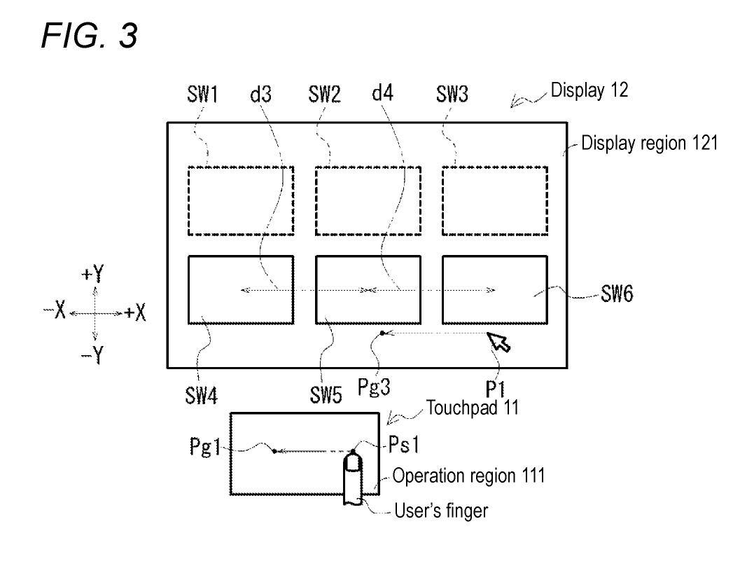

Based on a result of the determination, the control unit 16 displays switching image SW1 to SW6 as shown below. Specifically, when it is determined that the vehicle is stopped, since the user (here, a driver) of the vehicle is not driving and thus can safely perform operations, switching images SW1 to SW6 are switched to an operable state as shown in FIG. 2. Here, the “operable state” refers to the state of switching images. Specifically, the “operable state” is a state indicating that the switching images are displayed in an operable display state and are operable. Note that the “operable display state” refers to a display state that allows the user to recognize that the switching images are operable. Specifically, the “operable display state” is a display state different from an “inoperable display state” which will be described later, and is, for example, a color display (e.g., 256 levels of gray) state. On the other hand, when it is determined that the vehicle is traveling, the user (here, a driver) of the vehicle is driving and thus in order to prevent distracted driving, of the switching images SW1 to SW6 of FIG. 2, some switching images on which operations that require a relatively high level of attention are performed are switched to an inoperable state, and switching images other than those some switching images are switched to the operable state. Here, the “inoperable state” refers to the state of switching images. Specifically, the “inoperable state” is a state indicating that the switching images are displayed in an inoperable display state and are inoperable. Note that the “inoperable display state” refers to a display state that allows the user to recognize that the switching images are inoperable. Specifically, the “inoperable display state” is a display state different from the “operable display state” and is, for example, a state in which the switching images are toned down compared to those in the operable display state, and is a grayscale display state. FIG. 3 is a diagram illustrating the display on which switching images in the operable state and switching images in the inoperable state are displayed, and the touchpad. Here, the following description is made assuming, for example, that when it is determined that the vehicle is traveling, as shown in FIG. 3, switching images SW1 to SW3 are switched to the inoperable display state and switching images SW4 to SW6 are switched to the operable display state. Note that a screen displayed in the display area 121 of this FIG. 3 corresponds to an example of a “second display screen.”

(Processes—Amount-of-Movement Adjustment Process)

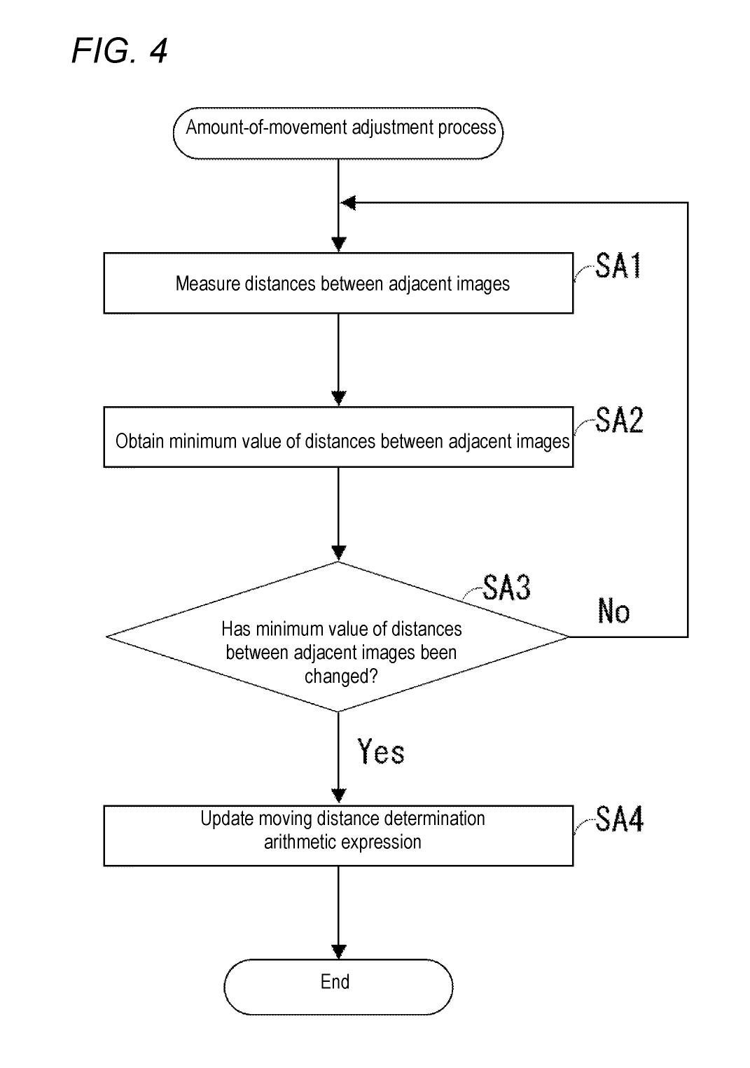

Next, the amount-of-movement adjustment process will be described. FIG. 4 is a flowchart of the amount-of-movement adjustment process (in the following description of each process, a step is abbreviated as “S”). The “amount-of-movement adjustment process” is a process of adjusting the amount of movement of the moving point. Specifically, the “amount-of-movement adjustment process” is a process of adjusting the moving distance of the pointer with respect to the operation distance on the touchpad and is, for example, a process of updating “d” of “Y=d×α×X” which is the moving distance determination arithmetic expression. The timing at which the amount-of-movement adjustment process is performed is any timing, but assuming, for example, that when the power to the in-vehicle apparatus 1 is turned on, the amount-of-movement adjustment process starts and is repeatedly performed, description is made from when the process has started.

As showing in FIG. 4, at SA1, the amount-of-movement determining unit 161 of the control unit 16 measures distances between the centers of adjacent switching images (hereinafter, the distances between adjacent images) of a plurality of switching images displayed on the display 12 of FIG. 1. Specifically, of switching images in the operable display state and switching images in the inoperable display state, only for the switching images in the operable display state, distances between adjacent images are measured. For the measurement technique, any technique including known techniques can be used, but the following description is made assuming, for example, that in the display 12 shown in FIGS. 2 and 3, as shown in the drawings, a coordinate system is set that includes a “Y-axis” which is parallel to an up-down direction (vertical direction) of the display 12 and which has the +Y side corresponding to the upper side and the −Y side corresponding to the lower side; an “X-axis” which is orthogonal to the Y-axis and parallel to a left-right direction (horizontal direction) of the display 12 and which has the +X side corresponding to the right side and the −X side corresponding to the left side; and an “origin” located at the center of the switching image SW5, and coordinates of the coordinate system are obtained, and measurement is performed based on the obtained coordinates.

Here, for example, in a case in which the vehicle is stopped and thus, as shown in FIG. 2, all switching images SW1 to SW6 are in the operable display state (hereinafter, simply referred to as “the case of FIG. 2”), the coordinates of the center of each of the switching images SW1 to SW6 are obtained, and based on the obtained coordinates, distances d1 to d7 shown in FIG. 2 are measured as distances between adjacent images. Note that in practice, distances between switching images adjacent to each other in diagonal directions that are not along the X-axis and the Y-axis (e.g., a distance between the switching image SW1 and the switching image SW5) are also measured, but here, for convenience of description, it is assumed that only distances between switching images adjacent to each other along the X-axis or the Y-axis are measured. In addition, the following description is made assuming that at this SA1, as the measured values of the distances d1 to d7, “md1” to “md7” (note that “md1” to “md7” are positive real numbers, e.g., “md1”=“md2”=“md3”=“md4”=“3 (centimeters)” and “md5”=“md6”=“md7”=“1 (centimeter)”) are obtained, assuming that the distances d1 to d4 have the same length, the distances d5 to d7 have the same length, and the distances d5 to d7 are shorter than the distances d1 to d4.

On the other hand, for example, in a case in which the vehicle is traveling and thus, as shown in FIG. 3, the switching images SW1 to SW3 are in the inoperable display state and the switching images SW4 to SW6 are in the operable display state (hereinafter, simply referred to as “the case of FIG. 3”), the coordinates of the centers of the switching images SW4 to SW6 are obtained, and based on the obtained coordinates, distances d3 and d4 shown in FIG. 3 are measured as distances between adjacent images, and “md3” and “md4” are obtained as measured values.

Referring back to FIG. 4, at SA2, the amount-of-movement determining unit 161 of the control unit 16 obtains the minimum value (minimum distance) among the distances between adjacent images. Specifically, the measured values which are measured at SA1 are obtained, the obtained measured values are compared with each other, and based on the results of the comparison, the minimum value among the measured values at SA1 is obtained. Here, for example, in “the case of FIG. 2,” “md1” to “md7” which are measured at SA1 are obtained, the obtained “md1” to “md7” are compared with each other, and the minimum value is obtained based on the results of the comparison. For example, “md5” is obtained. Note that since “md6” and “md7” are the same value as “md5,” at this SA2 “md6” or “md7” may be obtained, but here, the following description is made assuming that “md5” is obtained as described above. On the other hand, for example, in “the case of FIG. 3,” “md3” and “md4” which are measured at SA1 are obtained, and the obtained “md3” and “md4” are compared with each other. Since these values are the same value as described above, for example, “md3” is obtained. Note that since “md4” is the same value as “md3,” at this SA2 “md4” may be obtained, but here, the following description is made assuming that “md3” is obtained as described above.

Referring back to FIG. 4, at SA3, the amount-of-movement determining unit 161 of the control unit 16 determines whether the minimum value of the distances between adjacent images has been changed. Specifically, it is determined whether the minimum value obtained at SA2 has been changed. For the determination technique, any technique can be used, but here, the following description is made assuming, for example, that a technique is used in which every time the minimum value of the distances between adjacent images is changed, the changed value is recorded in the memory of the control unit 16 of FIG. 1 (note that immediately after starting the “amount-of-movement adjustment process,” for example, “NULL” is recorded as an initial value), the recorded value is compared with the minimum value obtained at SA2, and the determination is made based on a result of the comparison. Then, if the recorded value is the same as the minimum value obtained at SA2 (NO at SA3), it is determined that the minimum value of the distances between adjacent images has not been changed, and thus, processing transitions to SA1. In addition, if the recorded value differs from the minimum value obtained at SA2 (YES at SA3), it is determined that the minimum value of the distances between adjacent images has been changed, and thus, the minimum value obtained at SA2 is recorded in the memory of the control unit 16 and then processing transitions to SA4.

Referring back to FIG. 4, at SA4, the amount-of-movement determining unit 161 of the control unit 16 updates the moving distance determination arithmetic expression and then ends the amount-of-movement adjustment process. Specifically, the changed minimum value which is a value determined at the determination at SA3 to have been changed (i.e., the minimum value obtained at the latest SA2) is obtained, and the moving distance determination arithmetic expression is updated such that the obtained minimum value is “d” of “Y=d×α×X” which is the moving distance determination arithmetic expression recorded in the memory of the control unit 16. Here, for example, in “the case of FIG. 2,” since “md5” is obtained at SA2 of FIG. 4, “Y=d×α×X” is updated such that “d”=“md5.” On the other hand, for example, in “the case of FIG. 3,” since “md3” is obtained at SA2 of FIG. 4, “Y=d×α×X” is updated such that “d”=“md3.”

### (Processes—Movement Process)

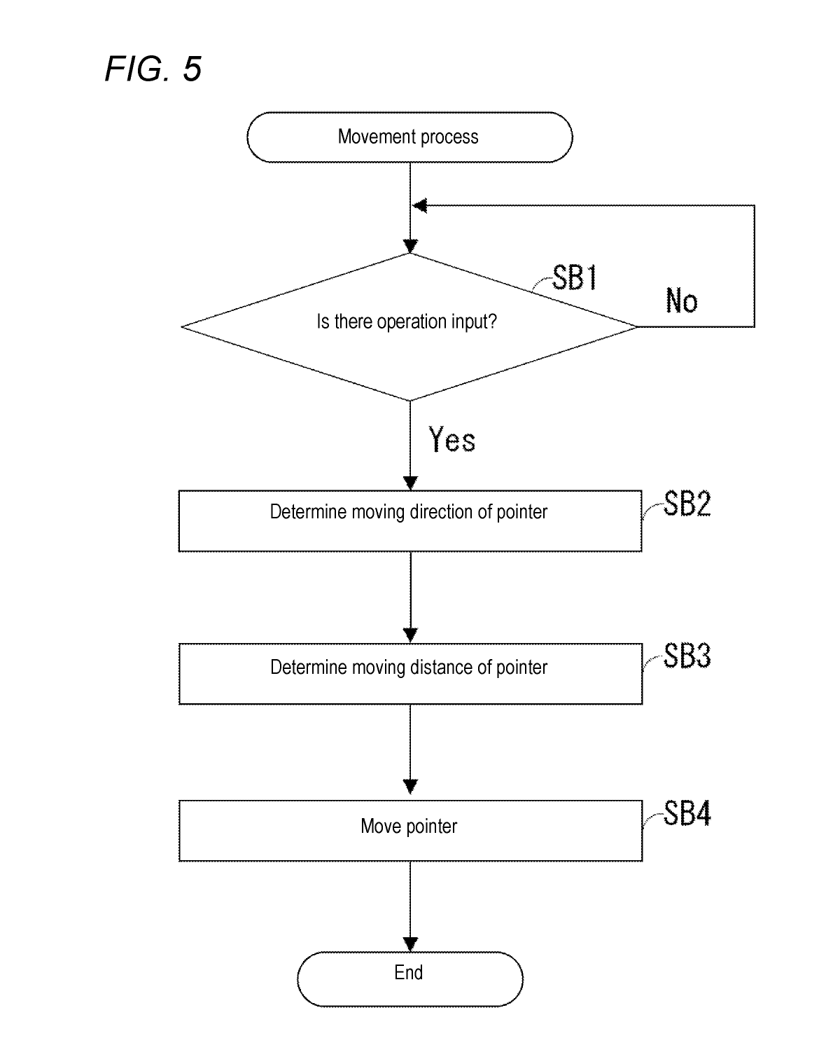

Next, the movement process will be described. FIG. 5 is a flowchart of the movement process. The “movement process” refers to a process of moving the moving point. Specifically, the “movement process” is a process of moving the pointer P1 in the display area 121 of the display 12, based on a user's operation input to the operation area 111 of the touchpad 11 of FIG. 2 or 3. The timing at which the movement process is performed is any timing, but assuming, for example, that when the power to the in-vehicle apparatus 1 is turned on, the movement process starts and is repeatedly performed, description is made from when the process has started. In addition, description is made showing an example case in which the coordinate system of the touchpad 11 of FIG. 2 or 3 corresponds to the XY-coordinate system of the display 12, a coordinate system with an origin at the center of the operation area 111 is set, and as an operation input to move the pointer P1 from right (+X side) to left (−X side) along the X-axis, an operation input to move a starting point Ps1 in the operation area 111 to an end point Pg1 on the left side along the X-axis by the “operation distance on the touchpad”=“5 (cm)” (hereinafter, the illustrated operation input) is inputted.

First, as shown in FIG. 5, at SB1, the control unit 16 determines whether there is an operation input. Specifically, whether there is an operation input through the operation area 111 of the touchpad 11 of FIG. 2 or 3 is monitored through the operation position detecting means provided in the operation area 111. Then, if an operation input is not detected through the operation position detecting means in the operation area 111, it is determined that there is no operation input (NO at SB1), and SB1 is repeatedly performed until an operation input is detected through the operation position detecting means in the operation area 111. In addition, if an operation input is detected through the operation position detecting means in the operation area 111, it is determined that there is an operation input through the touchpad 111 (YES at SB1), and thus, processing transitions to SB2. Here, for example, when the “illustrated operation input” is inputted, it is determined that there is an operation input through the touchpad 11, and processing transitions to SB2.

Referring back to FIG. 5, at SB2, the control unit 16 determines a moving direction of the pointer P1. Specifically, the coordinates of a starting point Ps1 and the coordinates of an end point Pg1 of FIG. 2 or 3 are obtained from the operation input which is inputted at SB1, and a moving direction is determined based on the obtained coordinates. Here, for example, the “moving direction of the pointer P1”=“left” is determined.

Referring back to FIG. 5, at SB3, the control unit 16 determines a moving distance of the pointer P1. Specifically, a moving distance of the pointer P1 is determined based on the operation input which is inputted at SB1 and “Y=d×α×X” which is the moving distance determination arithmetic expression recorded in the memory of the control unit 16. Furthermore, specifically, first, the coordinates of the starting point and end point of the operation input are obtained from the operation input which is inputted at SB1, and an “operation distance on the touchpad” is identified based on the obtained coordinates. Then, “Y=d×α×X” which is the moving distance determination arithmetic expression is read from the memory of the control unit 16, and the above-described identified “operation distance on the touchpad” is substituted for “X” of the read “Y=d×α×X,” by which the value of “Y” is calculated and the calculated value is determined as the moving distance of the pointer P1. Here, for example, first, the coordinates of the starting point Ps1 and end point Pg1 of FIG. 2 or 3 are obtained, and the “operation distance on the touchpad”=“5 (cm)” is identified based on the obtained coordinates, and then the following process is performed for each of “the case of FIG. 2” and “the case of FIG. 3” which are described at SA4 of FIG. 4. Specifically, in “the case of FIG. 2,” since “Y=d×α×X” is updated such that “d”=“md5” (i.e., “d”=“1 (centimeter)”), at this SB3 of FIG. 5, in “Y=d×α×X,” “d”=“1,” “a”=“0.5,” and “X”=“5,” and thus, “Y”=“2.5” is calculated and “2.5” (cm) which is the calculated value is determined as the moving distance of the pointer P1. On the other hand, in “the case of FIG. 3,” since “Y=d×α×X” is updated such that “d”=“md3” (i.e., “d”=“3 (centimeters)”), at this SB3 of FIG. 5, in “Y=d×α×X,” “d”=“3,” “a”=“0.5,” and “X”=“5,” and thus, “Y”=“7.5” is calculated and “7.5” (cm) which is the calculated value is determined as the moving distance of the pointer P1.

Then, at SB4, the control unit 16 moves the pointer P1 and then ends the movement process. Specifically, the pointer P1 of FIG. 2 or 3 is moved based on the current position of the pointer P1 and the results of the determination at SB2 and SB3. Furthermore, specifically, first, the coordinates of the current position of the pointer P1 are obtained, and the moving direction of the pointer P1 which is determined at SB2 of FIG. 5 and the moving distance of the pointer P1 which is determined at SB3 are obtained. Thereafter, the coordinates of a point that is away from the above-described obtained coordinates of the current position of the pointer P1 in the above-described obtained moving direction by the above-described obtained moving distance are identified, and the identified coordinates are obtained as the coordinates of the moved position of the pointer P1. Note that when the coordinates of the moved position of the pointer P1 are coordinates outside the display area 121 of FIG. 2 or 3, an intersection point of a straight line passing through the coordinates of the current position of the pointer P1 and the coordinates of the moved position, and the outermost periphery of the display area 121 is obtained as the coordinates of the moved position of the pointer P1. Then, in the display area 121 of FIG. 2 or 3, the pointer P1 is allowed to continuously move straight from the current position to a position corresponding to the above-described obtained coordinates of the moved position.

Here, for example, in each of “the case of FIG. 2” and “the case of FIG. 3” which are described at SB3, the following process is performed. Specifically, in “the case of FIG. 2,” first, the coordinates of the current position of the pointer P1 shown in FIG. 2 are obtained, and the “moving direction”=“left” and the “moving distance”=“2.5” (cm) are obtained. Thereafter, coordinates (coordinates corresponding to a moved position Pg2 of FIG. 2) that are away from the above-described obtained coordinates of the current position of the pointer P1 in the “left” direction by “2.5” (cm) are identified, and the identified coordinates are obtained. Then, in the display area 121 of FIG. 2, the pointer P1 is allowed to continuously move straight from the current position to the moved position Pg2. On the other hand, in “the case of FIG. 3,” first, the coordinates of the current position of the pointer P1 shown in FIG. 3 are obtained, and the “moving direction”=“left” and the “moving distance”=“7.5” (cm) are obtained. Thereafter, coordinates (coordinates corresponding to a moved position Pg3 of FIG. 3) that are away from the above-described obtained coordinates of the current position of the pointer P1 in the “left” direction by “7.5” (cm) are identified, and the identified coordinates are obtained. Then, in the display area 121 of FIG. 3, the pointer P1 is allowed to continuously move straight from the current position to the moved position Pg3. By such a configuration, for example, when the state of FIG. 2 has been changed to the state of FIG. 3 (i.e., when a first display screen is switched to a second display screen) by the stopped vehicle starting traveling, since “d” of the moving distance determination arithmetic expression is updated from “1” to “3,” the moving distance of the pointer with respect to the operation distance on the touchpad can be dynamically changed by the update. Accordingly, the moving distance of the pointer P1 can be dynamically determined according to the display state of the display 12, enabling to improve the ease of operation for an operation to select the plurality of switching images SW1 to SW6.

(Advantageous Effects of the Embodiment)

As such, according to the present embodiment, when the distances between a plurality of control images on a first display screen are different from the distances between a plurality of control images on a second display screen due to the switching of a display screen of the display 12 from the first display screen to the second display screen, the moving distance of the pointer P1 in the display area 121 with respect to the moving distance of a user's finger on the touchpad 11 is changed. Thus, for example, when the distances between a plurality of switching images SW1 to SW6 have been changed, the moving distance of the pointer P1 in the display area 121 with respect to the moving distance of a user's finger on the touchpad 11 can be changed, enabling to improve the ease of operation for an operation to select the plurality of switching images SW1 to SW6.

In addition, the moving distance of the pointer P1 in the display area 121 with respect to the moving distance of a user's finger on the touchpad 11 is determined based on the distances between a plurality of switching images in the operable display state among the switching images SW1 to SW6. Thus, for example, the moving distance of the pointer P1 in the display area 121 with respect to the moving distance of a user's finger on the touchpad 11 can be appropriately determined according to the distances between the plurality of switching images in the operable display state, enabling to improve the ease of operation for an operation to select the plurality of switching images in the operable display state.

In addition, the moving distance of the pointer P1 in the display area 121 with respect to the moving distance of a user's finger on the touchpad 11 is determined based on the minimum value of the distances between the switching images SW1 to SW6. Thus, for example, the switching images SW1 to SW6, for example, that have relatively small distances therebetween can be appropriately selected, enabling to further improve the ease of operation for an operation to select the plurality of switching images SW1 to SW6.

[Variants of the Embodiment]

Although the embodiment is described above, specific configurations may be changed and modified within the range of the technical inventive principles. Such variants will be described below.

First, the technical problems and advantageous effects are not limited to the above-described content, and may vary according to the implementation environment or the details of configurations, and only some of the above-described problems may be solved or only some of the above-described advantageous effects may be provided. For example, even if the ease of operation for operations performed using the operation system is comparable with the conventional one, when the ease of operation comparable with the conventional one is provided by a structure different from the conventional one, the problems described in the present application are solved.

In addition, the above-described electrical components are functionally conceptual and thus do not necessarily need to be physically configured in the manner shown in the drawings. Namely, specific modes of distribution and integration of each unit are not limited to those shown in the drawings, and they can be configured by functionally or physically distributing or integrating all or some of them in any unit according to various types of load, status of use, etc. The “system” of the present application is not limited to one that is composed of a plurality of apparatuses, and also includes one that is composed of a single apparatus. In addition, the “apparatus” of the present application is not limited to one that is composed of a single apparatus, and also includes one that is composed of a plurality of apparatuses. For example, the units of the in-vehicle apparatus 1 may be configured by distributing them to a plurality of apparatuses which are configured to be able to communicate with each other, and the same functions as those of the in-vehicle apparatus 1 may be exerted by the plurality of apparatuses communicating with each other.

(For Shapes, Numerical Values, Structures, and a Time Series)

Regarding the components illustrated in the embodiment and drawings, shapes, numerical values, or the structural or time-series interrelationship between a plurality of components may be arbitrarily changed and modified within the range of the technical inventive principles.

In addition, although the above-described embodiment describes a case in which at SA2 of FIG. 4, the minimum value of the distances between adjacent images is obtained and the amount-of-movement adjustment process is performed based on the obtained minimum value, for example, at SA2 of FIG. 4, instead of the minimum value of the distances between adjacent images, the maximum value (maximum distance) may be obtained and each step of the amount-of-movement adjustment process including SA3 may be performed based on the obtained maximum value. In addition, for example, at SA2 of FIG. 4, instead of the minimum value of the distances between adjacent images, a statistic (e.g., a mean or a median) of the distances between adjacent images may be obtained and each step of the amount-of-movement adjustment process including SA3 may be performed based on the obtained statistic. In addition, the user may be allowed to set a value obtained at SA2 of FIG. 4 (i.e., a minimum value, a maximum value, a statistic, or the like), and the value obtained at SA2 may be allowed to be changed according to the user's setting. By such configurations, the ease of operation can be improved according to user needs.

In addition, in the above-described embodiment, a lower limit value and an upper limit value may be set for “d” of “Y=d×α×X” which is updated at SA4 of FIG. 4, and the update may be performed such that “d” is a value in a range greater than or equal to the lower limit value and lower than or equal to the upper limit value. Here, the “lower limit value” is a minimum value that can be taken as “d” of “Y=d×α×X.” The value to be set is any, but the value can be set according to, for example, a reference based on the size of the operation area 111i of the touchpad 11 or the size of or distances between switching images SW1 to SW6 that can be displayed in the display area 121 of the display 12 of FIG. 2. Specifically, the value can be set to “0.5,” etc. In addition, the “upper limit value” is a maximum value that can be taken as “d” of “Y=d×α×X.” The value to be set is any, but the value can be set according to, for example, the same reference as that for the above-described lower limit value. Specifically, the value can be set to “10,” etc. In the case of such setting, for example, when a changed minimum value which is a value determined at the determination at SA3 of FIG. 4 to have been changed (hereinafter, simply the “changed minimum value”) is less than the lower limit value, an update is performed such that “d”=“lower limit value (e.g., 0.5)”; when the changed minimum value is greater than or equal to the lower limit value and lower than or equal to the upper limit value, an update is performed such that “d”=“changed minimum value”; and when the changed minimum value is greater than the upper limit value, an update is performed such that “d”=“upper limit value (e.g., 10).” Note that in this variant, a process may be performed by setting only one of the lower limit value and upper limit value. In addition, this variant may be applied to the above-described variations as well.

In addition, although the above-described embodiment describes a case in which “Y=d×α×X” which is the moving distance determination arithmetic expression is updated at SA4 using the changed minimum value which is a value determined at the determination at SA3 of FIG. 4 to have been changed (i.e., the “changed minimum value” described in “(For a lower limit value and an upper limit value)”) as “d” as it is, for example, the moving distance determination arithmetic expression may be updated such that the change rate of “d” which is updated at this SA4 is less than the change rate of the minimum value of the distances between adjacent images. As an example of this case, the moving distance determination arithmetic expression may be updated at SA4 of FIG. 4 such that a value (e.g., a mean or a median) between a value that is compared with the “changed minimum value” at the determination at SA3 and recorded in the memory of the control unit 16 of FIG. 1 (hereinafter, the “minimum value before the change”) and the “changed minimum value”=“d.” In this case, for example, when the “minimum value before the change”=“2” and the “changed minimum value”=“8,” at SA4 the moving distance determination arithmetic expression is updated with “d”=“5,” and for example, when the “minimum value before the change”=“10” and the “changed minimum value”=“2,” at SA4 the moving distance determination arithmetic expression is updated with “d”=“6.” In a case of such a configuration, when the distances between a plurality of control images have been changed, the amount of movement with respect to the amount of operation can be prevented from suddenly changing, enabling to prevent an erroneous operation arising from a sudden change in the amount of movement with respect to the amount of operation. Note that this variant may be applied to the above-described variations as well.

In addition, although the above-described embodiment describes a case in which “Y=d×α×X” which is the moving distance determination arithmetic expression is updated at SA4 using the “changed minimum value” as “d” as it is, for example, update value identifying information may be recorded in the data recording unit 15 of FIG. 1, and the moving distance determination arithmetic expression may be updated based on the recorded update value identifying information. Here, the “update value identifying information” is information that identifies a value to be updated. Specifically, the “update value identifying information” is information that identifies an updated “d” and is, for example, information in which a combination of a range of “changed minimum values” and the value of “d” is provided for a plurality of ranges of “changed minimum values.” As the “update value identifying information,” for example, a combination of a range of “changed minimum values”=“1 to 3” and “d”=“2” (hereinafter, the first combination) and a combination of a range of “changed minimum values”=“4 to 6” and “d”=“5” (second combination) are recorded. Then, in a case of thus recoding the combinations, when the “changed minimum value”=“2” at SA4, by referring to the update value identifying information, the “first combination” corresponding to the “changed minimum value”=“2” is identified, “d”=“2” in the identified first combination is obtained, and the moving distance determination arithmetic expression is updated such that “d” of “Y=d×α×X” is the obtained value “2.”

In addition, although the above-described embodiment describes a case in which the moving distance determination arithmetic expression is “Y=d×α×X” which is a linear equation, for example, an arithmetic expression of second or higher order may be used as the moving distance determination arithmetic expression.

In addition, although the above-described embodiment describes a case in which the moving distance of the pointer with respect to the operation distance on the touchpad is determined using only one moving distance determination arithmetic expression for one display screen (e.g., FIG. 2 or 3), for example, the “moving distance of the pointer” with respect to the “operation distance on the touchpad” (i.e., “d x a” of “Y=d×α×X” which is the moving distance determination arithmetic expression) may be changed on one display screen. For this case, specifically, by using two arithmetic expressions, a moving distance determination arithmetic expression for an operation input in a direction along the X-axis of FIG. 2 or 3 (hereinafter, the moving distance determination arithmetic expression for horizontal movement) and a moving distance determination arithmetic expression for an operation input in a direction along the Y-axis (hereinafter, the moving distance determination arithmetic expression for vertical movement), the “moving distance of the pointer” with respect to the “operation distance on the touchpad” may be determined according to the moving direction of the pointer P1. Furthermore, specifically, for the moving distance determination arithmetic expression for horizontal movement, it is configured such that in the “amount-of-movement adjustment process” of FIG. 4, distances in the direction along the X-axis between adjacent images are measured at SA1 and SA2 to SA4 are performed, and for the moving distance determination arithmetic expression for vertical movement, it is configured such that in the “amount-of-movement adjustment process” of FIG. 4, distances in the direction along the Y-axis between adjacent images are measured at SA1 and SA2 to SA4 are performed. Then, at SB3 of the “movement process” of FIG. 5, an operation input may be decomposed into a component in the direction along the X-axis and a component in the direction along the Y-axis, and the moving distance of the pointer may be determined using the “moving distance determination arithmetic expression for horizontal movement” and the “moving distance determination arithmetic expression for vertical movement” for the decomposed components in the directions along the X-axis and Y-axis. In such a configuration, for example, in FIG. 2, the moving distance of the pointer with respect to the operation distance on the touchpad for a case of moving the pointer P1 in the direction along the Y-axis can be made relatively small, and the moving distance of the pointer with respect to the operation distance on the touchpad for a case of moving the pointer P1 in the direction along the X-axis can be made relatively large. Thus, by operation inputs for similar operation distances, the pointer P1 on the display 12 can be moved by a distance corresponding to a distance between adjacent images of the switching images SW1 to SW6, enabling to improve the ease of operation for all directions including the directions along the X-axis and Y-axis. In addition, three or more moving distance determination arithmetic expressions for three or more directions, respectively, may be applied to the embodiment.

In addition, although the above-described embodiment describes a case in which distances between the centers of adjacent switching images are measured as distances between adjacent images at SA1 of FIG. 4, for example, spacings between adjacent control images may be measured as distances between adjacent images, or a predetermined measurement reference point may be set for each of adjacent control images and distances between the measurement reference points may be measured as distances between adjacent images.

In addition, although the above-described embodiment describes a case in which the moving point is the pointer P1 of FIG. 2, for example, the moving point may be a hidden (i.e., invisible) reference point on the display 12 which serves as a reference for selecting a control image. In this case, for example, it may be configured such that a plurality of control images (e.g., the control images may have the same configuration as the switching images SW1 to SW6 of FIG. 2) are displayed side by side in a horizontal direction (or any other direction) on the display 12 and the displayed control images are allowed to be alternatively selected according to the position of the reference point on the display 12, and then the same process as that of the embodiment may be performed. Regarding this case, as an example of a case of alternatively selecting one of two images, it is configured such that a first control image is displayed on the left side of the display 12 and a second control image is displayed on the right side of the display 12, and when a user's finger moves from left to right on the touchpad 11, the reference point moves from the first control image side to the second control image side by a distance corresponding to the moving distance of the finger, and when the user's finger moves from right to left on the touchpad 11, the reference point moves from the second control image side to the first control image side by a distance corresponding to the moving distance of the finger. Furthermore, in this example, it may be configured such that, when one of the first control image and the second control image is selected, by moving the reference point from a position that is present over the one control image to a position that is present over the other control image, the one control image is unselected and the other control image is selected, and then the same process as that of the embodiment may be performed. In this case, when the distance between the first control image and the second control image has been changed, the moving distance of the reference point on the display 12 with respect to the moving distance of the user's finger on the touchpad 11 also changes according to the change in the distance between the first control image and the second control image. Thus, a control image can be selected by the same operation as an operation performed before the distance between the first control image and the second control image changes, without changing the moving distance of the user's finger on the touchpad 11.

In addition, although the above-described embodiment describes a case of using the touchpad 11 of FIG. 1 as the operating means, for example, as the operating means, a touch panel which is provided at the front of the display 12 so as to be laid over the display area 121 of the display 12 may be used. In this case, it may be configured such that switching images SW1 to SW6 are displayed in a first region (e.g., an upper two-thirds region) of a region where the touch panel is laid over the display area 121 (hereinafter, the laid-over region) and the touch panel in a second region (e.g., a lower one-third region) which is a region other than the first region of the laid-over region is operated, and then the same process as that of the embodiment may be performed. In addition, for example, as the operating means, a mouse, a trackball, or a joystick may be used. In each of the cases of thus using a mouse, a trackball, and a joystick, the same process as that of the embodiment may be performed using the amount of rotation of a mouse ball, the amount of rotation of the trackball, and the amount of tilt of the joystick as the “amount of operation.”

In addition, in the above-described embodiment, when looking at a case in which the stopped vehicle starts traveling, as described above, the display screen of FIG. 2 corresponds to the “first display screen” and the display screen of FIG. 3 corresponds to the “second display screen.” However, these “first display screen” and “second display screen” are determined by a relative display order, i.e., when looking at a case in which a traveling vehicle stops, the display screen of FIG. 2 corresponds to the “second display screen” and the display screen of FIG. 3 corresponds to the “first display screen.”

In addition, although the above-described embodiment describes a case in which the “first display screen” and the “second display screen” are “screens including switching images with different display states on a menu screen,” for example, when the “first display screen” and the “second display screen” are “screens including character input images with different display states on a 50-sound input screen,” the technique described in the embodiment may be applied. For this case, specifically, it may be configured such that a “plurality of character input images” are assigned, for example, 50 sounds, respectively, so that an assigned character can be inputted by selecting it, and it may be configured such that in order to aid in inputting candidate information based on information which is registered in advance (e.g., the facility name or address of a destination), only candidate characters to be inputted next are brought into the operable display state (i.e., all characters other than the candidate characters to be inputted next are toned down to the inoperable display state), and then the technique described in the embodiment may be applied. In this case, when the display state of each character input image is changed between, for example, the operable display state and the inoperable display state by inputting characters and the distance between a plurality of character input images in the operable display state is changed, the amount of movement with respect to the amount of operation can be changed, enabling to improve the ease of operation for operating the character input images.

In addition, for example, when the “first display screen” and the “second display screen” are “display screens including control images of different types,” the technique described in the embodiment may be applied. For this case, specifically, it may be configured such that the display screen of the display 12 is switched to a menu screen or a 50-sound input screen automatically at predetermined timing (e.g., timing at which the vehicle stops traveling or the vehicle starts traveling) or manually by a user's input of a predetermined operation through the touchpad 11 of FIG. 1, and then the technique described in the embodiment may be applied. In this case, when distances between a plurality of switching images on the menu screen are different in advance from distances between a plurality of character input images on the 50-sound input screen, for example, by changing the amount of movement with respect to the amount of operation when the menu screen is switched to the 50-sound input screen, the ease of operation for operating the character input images can be improved, or by changing the amount of movement with respect to the amount of operation when the 50-sound input screen is switched to the menu screen, the ease of operation for operating the switching images can be improved.

[Some of the Features and Advantageous Effects of the Embodiment]

Finally, some of the features and advantageous effects of the embodiment described above are illustrated below. Note, however, that the features and advantageous effects of the embodiment are not limited to the following content, and there is a case in which by having only some of the following features, only some of the following advantageous effects are provided, or a case in which by having other features than the following features, other advantageous effects than the following advantageous effects are provided.

An operation system according to one aspect 1 of the embodiment is an operation system including: display means having a display area in which a display screen is displayed, the display screen including a plurality of control images to be selected to control a to-be-controlled object; operating means having an operation area to be operated to move a moving point in the display area of the display means, the operation area being not laid over the display area of the display means, and the moving point being for selecting the plurality of control images; and amount-of-movement determining means for determining an amount of movement of the moving point in the display area of the display means with respect to an amount of operation in the operation area of the operating means, and when a distance between the plurality of control images on a first display screen is different from a distance between the plurality of control images on a second display screen due to switching of the display screen of the display means from the first display screen to the second display screen, the amount-of-movement determining means changes the amount of movement with respect to the amount of operation.

According to the operation system according to the aspect 1, when a distance between a plurality of control images on a first display screen is different from a distance between the plurality of control images on a second display screen due to the switching of the display screen of the display means from the first display screen to the second display screen, the amount of movement with respect to the amount of operation is changed. Thus, for example, when a distance between a plurality of control images has been changed, the amount of movement of the moving point in the display area with respect to the amount of operation in the operation area can be changed, enabling to improve the ease of operation for an operation to select the plurality of control images.

An operation system according to another aspect 2 of the embodiment is such that in the operation system according to the aspect 1, each of the plurality of control images is switched to an operable display state or an inoperable display state, and the amount-of-movement determining means determines the amount of movement with respect to the amount of operation, based on a distance between the plurality of control images in the operable display state.

According to the operation system according to the aspect 2, the amount of movement with respect to the amount of operation is determined based on a distance between a plurality of control images in the operable display state. Thus, for example, the amount of movement of the moving point in the display area with respect to the amount of operation in the operation area can be appropriately determined according to the distance between the plurality of control images in the operable display state, enabling to improve the ease of operation for an operation to select the control images in the operable display state.

An operation system according to another aspect 3 of the embodiment is such that in the operation system according to the aspect 1 or 2, the amount-of-movement determining means determines the amount of movement with respect to the amount of operation, based on a minimum distance among distances between adjacent control images of the plurality of control images.

According to the operation system according to the aspect 3, the amount of movement with respect to the amount of operation is determined based on the minimum distance among the distances between control images. Thus, for example, control images having a relatively small distance therebetween can be appropriately selected, enabling to further improve the ease of operation for an operation to select a plurality of control images.

An operation system according to another aspect 4 of the embodiment is such that in the operation system according to any one of the aspects 1 to 3, when a distance between the plurality of control images is changed, the amount-of-movement determining means determines the amount of movement with respect to the amount of operation such that a change rate of the amount of movement with respect to the amount of operation is less than a change rate of the distance between the plurality of control images.

According to the operation system according to the aspect 4, the amount of movement with respect to the amount of operation is determined such that the change rate of the amount of movement with respect to the amount of operation is less than the change rate of a distance between a plurality of control images. Thus, for example, when the distance between a plurality of control images have been changed, the amount of movement with respect to the amount of operation can be prevented from suddenly changing, enabling to prevent an erroneous operation arising from a sudden change in the amount of movement with respect to the amount of operation.

An operation method according to another aspect 5 of the embodiment is an operation method for an operation system including: display means having a display area in which a display screen is displayed, the display screen including a plurality of control images to be selected to control a to-be-controlled object; operating means having an operation area to be operated to move a moving point in the display area of the display means, the operation area being not laid over the display area of the display means, and the moving point being for selecting the plurality of control images; and amount-of-movement determining means for determining an amount of movement of the moving point in the display area of the display means with respect to an amount of operation in the operation area of the operating means, and the operation method includes: an amount-of-movement determining step of changing, by the amount-of-movement determining means, the amount of movement with respect to the amount of operation when a distance between the plurality of control images on a first display screen is different from a distance between the plurality of control images on a second display screen due to switching of the display screen of the display means from the first display screen to the second display screen.

According to the operation method according to the aspect 5, when a distance between a plurality of control images on a first display screen is different from a distance between the plurality of control images on a second display screen due to the switching of the display screen of the display means from the first display screen to the second display screen, the amount of movement with respect to the amount of operation is changed. Thus, for example, when a distance between a plurality of control images has been changed, the amount of movement of the moving point in the display area with respect to the amount of operation in the operation area can be changed, enabling to improve the ease of operation for an operation to select the plurality of control images.

An operation program according to another aspect 6 of the embodiment is an operation program for an operation system including: display means having a display area in which a display area including a plurality of control images is displayed, the plurality of control images being selected to control a to-be-controlled object; operating means having an operation area to be operated to move a moving point in the display area of the display means, the operation area being not laid over the display area of the display means, and the moving point being for selecting the plurality of control images; and amount-of-movement determining means for determining an amount of movement of the moving point in the display area of the display means with respect to an amount of operation in the operation area of the operating means, and the operation program causes a computer to function as: the amount-of-movement determining means for changing the amount of movement with respect to the amount of operation when a distance between the plurality of control images on a first display screen is different from a distance between the plurality of control images on a second display screen due to switching of the display screen of the display means from the first display screen to the second display screen.

According to the operation program according to the aspect 6, when a distance between a plurality of control images on a first display screen is different from a distance between the plurality of control images on a second display screen due to the switching of the display screen of the display means from the first display screen to the second display screen, the amount of movement with respect to the amount of operation is changed. Thus, for example, when a distance between a plurality of control images has been changed, the amount of movement of the moving point in the display area with respect to the amount of operation in the operation area can be changed, enabling to improve the ease of operation for an operation to select the plurality of control images.

1. An operation system comprising:
a display having a display area in which a first display screen and a second display screen are displayed, each of the first display screen and the second display screen including a plurality of control images to be selected to control a to-be-controlled object;
operating means having an operation area to be operated to move a moving point in the display area, the operation area being not laid over the display area, the moving point being for selecting the plurality of control images; and
a processor programmed to:
determine an amount of movement of the moving point in the display area with respect to an amount of operation in the operation area;
when a distance between the plurality of control images on the first display screen is different from a distance between the plurality of control images on the second display screen due to switching from the first display screen to the second display screen, change the amount of movement with respect to the amount of operation.

2. The operation system according to claim 1, wherein:
each of the plurality of control images is switched to an operable display state or an inoperable display state; and
the processor is programmed to determine the amount of movement with respect to the amount of operation, based on a distance between the plurality of control images in the operable display state.

3. The operation system according to claim 1, wherein the processor is programmed to determine the amount of movement with respect to the amount of operation, based on a minimum distance among distances between adjacent control images of the plurality of control images.

4. The operation system according to claim 1, wherein the processor is programmed to determine, when a distance between the plurality of control images is changed, the the amount of movement with respect to the amount of operation such that a change rate of the amount of movement with respect to the amount of operation is less than a change rate of the distance between the plurality of control images.

5. An operation method for an operation system including:
displaying a display screen having a display area in which a first display screen and a second display screen are displayed, each of the first display screen and the second display screen including a plurality of control images to be selected to control a to-be-controlled object;
receiving a signal from an operating means having an operation area to be operated to move a moving point in the display area, the operation area being not laid over the display area, and the moving point being for selecting the plurality of control images;
based on the received signal, determining an amount of movement of the moving point in the display area with respect to an amount of operation in the operation area; and
changing the amount of movement with respect to the amount of operation when a distance between the plurality of control images on the first display screen is different from a distance between the plurality of control images on the second display screen due to switching from the first display screen to the second display screen.

6. A computer-readable storage medium storing a computer-executable operation program for an operation system, the program causing the computer to perform functions including:
displaying a display screen having a display area in which a first display screen and a second display screen are displayed, each of the first display screen and the second display screen including a plurality of control images to be selected to control a to-be-controlled object;
receiving a signal from an operating means having an operation area to be operated to move a moving point in the display area, the operation area being not laid over the display area, and the moving point being for selecting the plurality of control images;
based on the received signal, determining an amount of movement of the moving point in the display area with respect to an amount of operation in the operation, area; and
changing the amount of movement with respect to the amount of operation when a distance between the plurality of control images on the first display screen is different from a distance between the plurality of control images on the second display screen due to switching from the first display screen to the second display screen.
